(19) United States
(12) Patent Application Publication
(10) Pub. No.: US 2025/0187412 A1
(43) Pub. Date: Jun. 12, 2025

(54) FOLDING TYPE CARGO COMPARTMENT COVER UNIT HAVING A SEALING STRUCTURE

(71) Applicants: HYUNDAI MOTOR COMPANY, Seoul (KR); KIA CORPORATION, Seoul (KR); AUTOMOBILE INDUSTRIAL ACE, Ansan-si (KR)

(72) Inventors: Hyung-Sik Choi, Hwaseong-si (KR); Jae-Seung Lee, Hwaseong-si (KR); Si-Won Lee, Yangsan-si (KR); Min-Su Kim, Seoul (KR); Woo-Sik Yoon, Incheon (KR)

(73) Assignees: HYUNDAI MOTOR COMPANY, Seoul (KR); KIA CORPORATION, Seoul (KR); AUTOMOBILE INDUSTRIAL ACE, Ansan-si (KR)

(21) Appl. No.: 18/755,260

(22) Filed: Jun. 26, 2024

(30) Foreign Application Priority Data
Dec. 7, 2023 (KR) 10-2023-0176725

(51) Int. Cl. B60J 7/14

(52) U.S. Cl. CPC B60J 7/141

(57) ABSTRACT

A folding type cargo compartment cover unit having a sealing structure includes: a plurality of slats successively arranged on top of a vehicular cargo compartment along one direction of a vehicle; connectors, each being arranged between the adjacent slats; shafts, each hinge-connecting one of the adjacent slats and the connector to each other by passing through the one of the adjacent slats and through the connector; and weather strips, each being formed of flexible material and being provided on at least one of the slat or the connector, thereby sealing a gap between the slat and the connector.

### CROSS-REFERENCE TO RELATED APPLICATION

This application claims priority to Korean Patent Application No. 10-2023-0176725, filed on Dec. 7, 2023, which is incorporated herein by reference in its entirety.

### BACKGROUND OF THE DISCLOSURE

### Field of the Disclosure

The present disclosure relates to a vehicular cargo compartment cover unit, and more particularly, to a folding type cargo compartment cover unit capable of blocking foreign material or moisture.

### Description of Related Art

The vehicles, such as pick-up trucks, each have a cargo compartment of predetermined size in the rear side.

The cargo compartment has a cover in order to protect a cargo loaded in the cargo compartment. For example, the cover may be provided as a roll shutter-type in order to reduce its volume occupying in the cargo compartment. However, in order to store the roller shutter-type cover, a space was required inside the cargo compartment for installing a case that accommodate the roll shutter type cover. Accordingly, a problem arises in that an internal space within the cargo compartment is reduced. In addition, when a mid-gate installed between a passenger compartment and the cargo compartment is open to load a long-sized cargo, the case obstructs the space formed by the opening of the mid gate, thereby hindering a loading operation of the long-sized cargo.

In order to address this problem, as illustrated in FIGS. 1-5, a folding type cargo compartment cover unit 110 has been proposed. The compartment cover unit 110 has a plurality of slats 111 connected to each other in a zigzag-foldable manner to open and close a cargo compartment 101 of a vehicle 100.

A connector is arranged between the adjacent slats 111, and shafts 113 connect the connector 112 and the adjacent slats 111. In this manner, the cover unit 110 employs a structure where the plurality of slats 111 are foldable in a zigzag manner. An upper bracket 123 is fastened to the outsides of upper portions, to which the connector 112 is connected, of the adjacent slats 111, and a lower bracket 124 is fastened to the outsides of lower portions, to which the connector 112 is connected, of the adjacent slats 111. Movable blocks 123a and 124a are formed on the upper bracket 123 and the lower bracket 124, respectively. The movable blocks 123a and 124a unfold the cover unit 10 or fold the cover unit 10 in a zigzag manner while moving along a main rail 121 and a guide rail 122, respectively, disposed on the cargo compartment 101. The movable block 123a on the upper bracket 123 is positioned more outward in a widthwise direction of the vehicle 100 than the movable block 124a on the lower bracket 124. A tracking path along which the movable block 123a on the upper bracket 123 moves is formed along the main rail 121 and the guide rail 122, and a tracking path along which the movable block 124a on the lower bracket 124 moves is formed on the main rail 121. The movable block 123a on the upper bracket 123 moves along the main rail 121 and the guide rail 122, and the movable block 124a on the lower bracket 124 moves along the main rail 121

A drive motor 133 and a drive gear 134 driven by the drive motor 133 are installed between a housing 131 and the cover 132, and a cable 135 is operated by the drive gear 134. When the drive motor 133 operates in a state where the cover unit 110 is spread out, i.e., unfold, the cable 135 pulls the rear end portion of the cover unit 110 toward the front of the vehicle 100. Thus, the movable block 123a moves by a predetermined distance along the main rail 121. Then, the movable block 123a on the upper bracket 123 moves toward the guide rail 122, while the movable block 124a on the lower bracket 124 continues to move along the main rail 121. Accordingly, the slats 111 rotate, and thus, the cover unit 110 is folded in a zigzag manner. Conversely, when the drive motor 133 operates in a state where the cover unit 110 is folded in a zigzag manner, the cable 135 operates reversely to move the rear end portion of the cover unit 110 toward the rear side of the vehicle 100. Thus, the slats 111 moves, and thus, the cover unit 110 is spread out.

However, because a sealing member is not provided between the two adjacent slats 111 and the connector 112, moisture or foreign material may penetrate into the cargo compartment 101, thereby causing damage to the cargo loaded in the cargo compartment 101.

The connector 112 becomes in a direct contact with the two adjacent slats 111, leaving no gap therebetween to be sealed. Accordingly, when the cover unit 110 is spread out or folded in a zigzag manner, moisture or foreign material readily penetrates into a gap between the slat 111 and connector 112 (refer to dotted arrows in FIGS. 4 and 5). In addition, the repetitive operations of the cover unit 110 may reduce the durability of the slats 111 and the connector 112, thereby causing the wear and tear thereof.

The statements in this section merely provide background information related to the present disclosure and may not constitute prior art.

### SUMMARY OF THE DISCLOSURE

An object of the present disclosure, which is made to address the above-mentioned problems, is to provide a sealing function-improved vehicular cargo compartment zigzag-foldable cover unit capable of preventing moisture or foreign material from penetrating into a cargo compartment by including a weather strip for sealing a gap between a slat and a connector.

In order to accomplish the above-mentioned object, one aspect of the present disclosure provides a folding type cargo compartment cover unit. The folding type cargo compartment cover unit (hereinafter “the foldable cargo compartment cover unit,” “the cargo compartment cover unit,” or “the cover unit”) includes: a plurality of slats successively arranged on top of a vehicular cargo compartment along one direction of a vehicle; connectors, each being arranged between the adjacent slats of the plurality of slats; and shafts, each hinge-connecting one slat of the adjacent slats and a connector, among the plurality of connectors, to each other by passing through the one of the adjacent slats and the connector. The cargo compartment cover unit further includes: weather strips, each being formed of flexible material and being provided on at least one of the slat or the connector, thereby sealing a gap between the slat and the connector.

In an embodiment, the weather strips may include a slat weather strip fixed by being inserted into an end portion of the slat and sealing a gap between the slat and the connector by coming into close contact with the outside of the connector.

In an embodiment, the weather strip may include: a first fastening portion fastening the slat weather strip to the slat by being inserted into the slat; a first sealing portion convexly formed toward the connector to come into contact with the connector; a second sealing portion coming into contact with the connector to surround one side thereof; a connection portion connecting the first sealing portion and the second sealing portion to each other; and a first neck portion formed between the first fastening portion and the connection portion in a manner to have a smaller width than the first fastening portion.

In an embodiment, a first weather strip insertion portion may be formed in the shape of an elongated hole in the slat along the lengthwise direction of the slat, and the first fastening portion may be inserted into the first weather strip insertion portion.

In an embodiment, the connector may have convex portions convexly formed to come into contact with the first sealing portions, respectively, and the first sealing portions may be convexly formed toward the convex portions, respectively.

In an embodiment, extension portions may be formed, toward the adjacent slat, on the slats, respectively, and the first sealing portion may be supported on an inner surface of the extension portion.

In an embodiment, the extension portion may extend from an upper surface or lower surface of the slat.

In an embodiment, a flat portion of the connector may be formed in the opposite direction to the convex portions of the connector.

In another embodiment, the second sealing portion may be formed to extend from the connection portion in the direction of moving away from the first sealing portion and then to extend backward toward the first sealing portion.

In an embodiment, a protrusion may be formed on a portion of the second sealing portion that extends toward the first sealing portion.

In an embodiment, a through-hole in the connector into which the shaft is inserted may be provided in pairs, and thus the connector may be hinge-connected to the two adjacent slats.

In an embodiment, the weather strip may be a connector weather strip that is fixed to the connector by being inserted thereinto and may seal a gap between the two adjacent slats.

In an embodiment, the connector weather strip may include: a second fastening portion fastening the connector weather strip to the connector by being inserted into the connector; and a third sealing portion coming into contact with the two adjacent slats, thereby sealing a gap therebetween, when the cover unit is spread out. The connector weather strip may further include a second neck portion that is formed to have a smaller width than the second fastening portion and connects the second fastening portion and the third sealing portion to each other.

In another embodiment, a second weather strip insertion portion may be formed in the shape of an elongated hole in the connector along the lengthwise direction of the connector, and the second fastening portion may be inserted into the second weather strip insertion portion.

In an embodiment, the third sealing portion may have a hollow space inside.

In an embodiment, the third sealing portion may be formed in such a manner that a width thereof increases toward the second neck portion from an end of the third sealing portion.

In an embodiment, extension portions may be formed, toward the adjacent slat, on the adjacent slats, respectively, and the third sealing portion may seal a gap between the extension portions.

In an embodiment, the extension portion may extend from an upper and lower surface of the slat.

In embodiment, the two adjacent slats may be formed to have the same height when the cover unit is spread out.

With the cargo compartment cover unit described above, according to the present disclosure, the slat weather strip and the connector weather strip may be provided between the slits and the connector. Thus, a phenomenon where moisture or foreign material penetrates between the slats and the connector may be avoided or prevented.

In addition, the slat weather strip and the connector weather strip may enhance sealing performance, thereby reducing the gap between the slat and connector. Thus, when the slats are spread out (unfold) or folded in a zigzag manner, the connector may not come into direct contact with the slats, thereby improving the durability of the cover unit and preventing the wear and tear thereof.

### BRIEF DESCRIPTION OF THE DRAWINGS

FIG. 1 is a perspective view illustrating a state where a folding type cover unit in the related art is installed on a vehicular cargo compartment.

FIG. 2 is a perspective view illustrating a state where the folding type cover unit in the related art is spread out.

FIG. 3 is an exploded perspective view illustrating the folding type cover unit in the related art.

FIG. 4 is a cross-sectional view taken along line A-A on FIG. 2.

FIG. 5 is a cross-sectional view taken along line B-B on FIG. 3.

FIG. 6 is a cross-sectional view illustrating a sealing structure at upper portions of two adjacent slats in a state where a folding type cargo compartment cover unit according to the present disclosure is spread out.

FIG. 7 is an exploded cross-sectional view illustrating the sealing structure of FIG. 6 in an embodiment of the present disclosure.

FIG. 8 is a cross-sectional view illustrating that a gap between lower extension portions of the two adjacent slats is sealed in a state where the folding type cargo compartment cover unit according to the present disclosure is spread out.

FIG. 9 is a cross-sectional view illustrating an upper connecting portion of adjacent slats of the folding type cargo compartment cover unit according to the present disclosure.

FIG. 10 is a cross-sectional view illustrating a lower connecting portion of adjacent slats of the folding type cargo compartment cover unit according to the present disclosure.

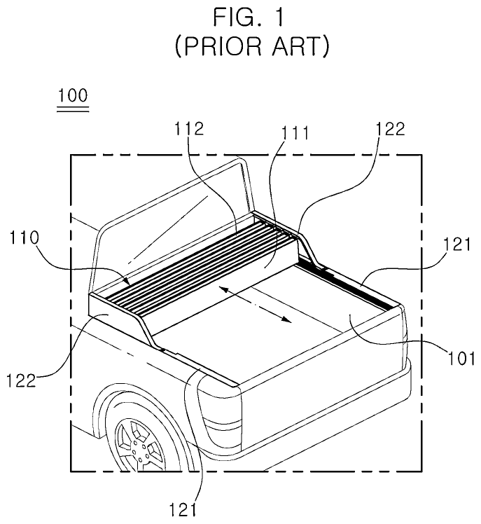

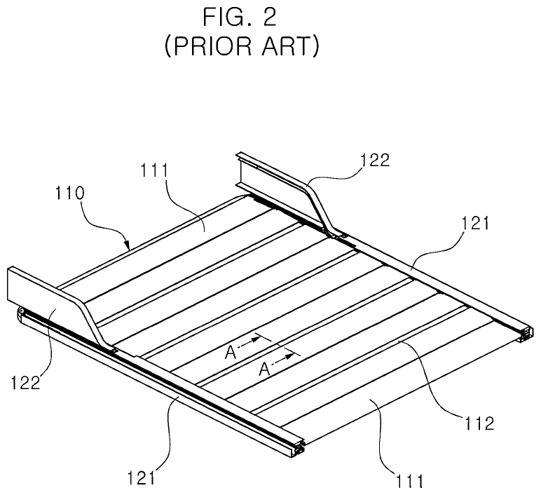

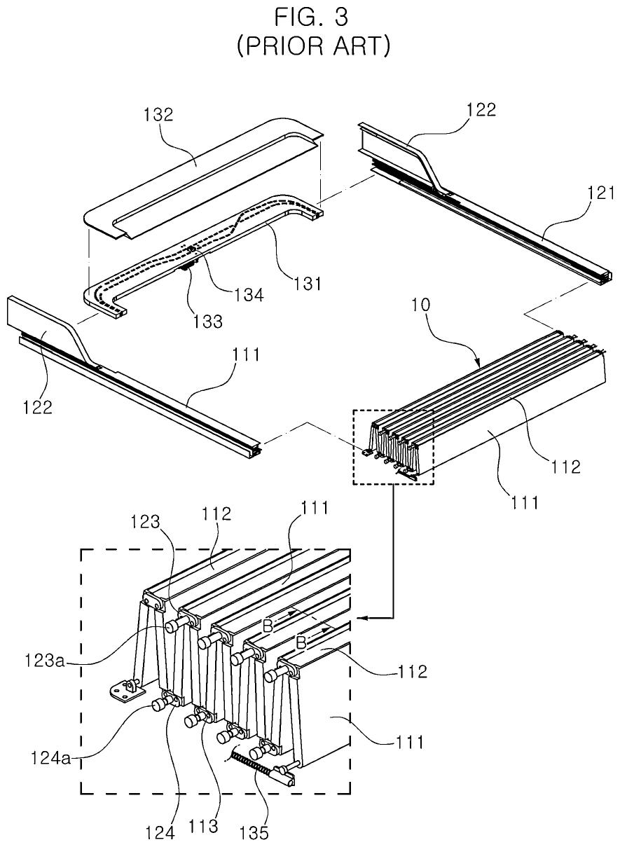

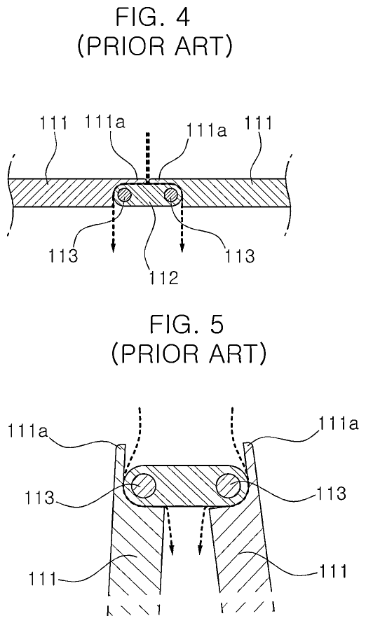

The drawings described herein are for illustration purposes only and are not intended to limit the scope of the present disclosure in any way.

### DESCRIPTION OF SPECIFIC EMBODIMENTS

A folding type cargo compartment cover unit with a sealing structure according to the present disclosure is described in detail below with reference to the accompanying drawings.

When a component, device, element, or the like of the present disclosure is described as having a purpose or performing an operation, function, or the like, the component, device, or element should be considered herein as being “configured to” meet that purpose or to perform that operation or function.

The folding type cargo compartment cover unit with a sealing structure according to the present disclosure may include: a plurality of slats 11 successively arranged along one direction of a vehicle on top of a vehicular cargo compartment; connectors 12, each being arranged between the adjacent slats 11; and shafts 13, each hinge-connecting one of the adjacent slats 11 and the connector 12 to each other by passing through the one of the adjacent slats 11 and through the connector 12. The cover unit further includes: weather strips 14 and 15, each being formed of flexible material and being provided on at least one of the slat 11 or the connector 12, thereby sealing a gap between the slat 11 and the connector 12.

The cover unit 10 according to the present disclosure may be mounted on top of the vehicular cargo compartment. With a drive mechanism installed in the vehicular cargo compartment, the cover unit 10 may be unfold or spread out to cover the upper portion of the vehicular cargo compartment or may be folded in a zigzag manner to open the upper portion thereof.

The slats 11 may be successively arranged along one direction of the vehicle on top of the vehicular cargo compartment. Normally, the cover unit 10 may be spread out or folded in a zigzag manner along the lengthwise direction of the vehicle. Accordingly, the slats 11 formed in a widthwise direction of the vehicle may be arranged along the lengthwise direction of the vehicle. In other words, the slats 11 are elongated and their long sides align with the widthwise direction of the vehicle. The slats 11 are positioned sequentially along the lengthwise direction of the vehicle. When the cover unit 10 is fully spread out (i.e., fully unfolding the slats), all the slats 11 may be arranged in parallel with the ground and close the upper portion of the vehicular cargo compartment. When the cover unit 10 is folded in a zigzag manner, the slats 11 may be arranged in an upright position and then move toward a front side of the vehicular cargo compartment, thereby opening the upper portion of the vehicular cargo compartment.

An extension portion 11a and 11b may be formed on the end portion of each slat 11 in the lengthwise direction of the vehicle in a manner that extends toward the adjacent slat 11.

Each slat 11 may include an upper extension portion 11a, extending from an upper surface of the slat 11, and a lower extension portion 11b, extending from a lower surface of the slat 11. One of the upper and lower extension portions 11a and 11b may be formed on the front end portion of the slat 11, and the other one of the upper and lower extension portions 11a and 11b may be formed on the rear end portion of the slat 11. For example, in a case where the lower extension portion 11b is formed on the front end portion of the slat 11, the upper extension portion 11a may be formed on the rear end portion of the slat 11. Alternatively, in a case where the upper extension portion 11a is formed on the front end portion of the slat 11, the lower extension portion 11b may be formed on the rear end portion of the slat 11.

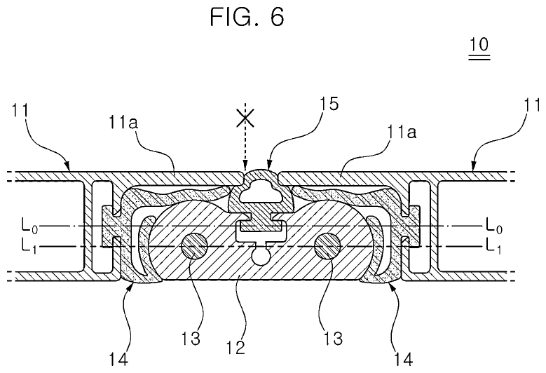

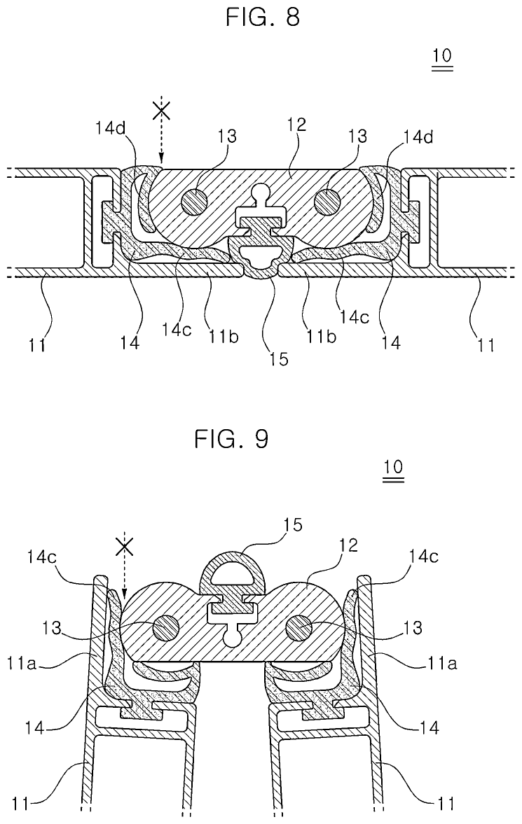

The slats 11 may be arranged in such a manner that the extension portions 11a and 11b are adjacent to each other. For example, the two adjacent slats 11 may be arranged in such a manner that the upper extension portions 11a are adjacent to each other (refer to FIG. 6) or that the lower extension portions 11b are adjacent to each other (refer to FIG. 8).

In another embodiment, a first weather strip insertion portion 11c in the shape of an elongated hole may be formed in the slat 11 along the lengthwise direction of the slat 11. The first weather strip insertion portion 11c may have an opening with a slit-shaped cross section and contains a space formed inside. A slat weather strip 14 may be fixed into the first weather strip insertion portion 11c by being inserted into the space.

The connector 12 may be arranged between the two adjacent slats 11. The connector 12 may contain a through-hole 12a formed in pairs. The shafts 13 may be inserted into the through-hole 12a, respectively. Thus, the two adjacent slats 11 may be spread out or folded in a zigzag manner through the shafts 13. The slat 11 may be formed in a manner that an end portion thereof is inclined inward. The shaft 13 may pass through the inward-inclined end portion of the slat 11 and may be inserted into the through-hole 12a, thereby hinge-connecting the slat 11 and the connector 12 to each other. The connector 12 may be arranged between the two adjacent slats 11 to each other and may be hinge-connected to each of the two adjacent slats 11.

The connector 12 may have convex portions 12c convexly formed to face the upper extension portions 11a formed on the front end portions of the two adjacent slats 11, respectively, and a flat portion 12b formed in the opposite direction to the convex portions 12c.

In an embodiment, a second weather strip insertion portion 12d may be formed between the two convex portions 12c. A connector weather strip 15 described below may be fixed into the second weather strip insertion portion 12d by being inserted thereinto.

The connector 12 may be hinge-connected to the two adjacent slats 11 through the shafts 13 respectively inserted in the through-holes 12a of the connector. In order to avoid the interference when the two adjacent slats 11 and the connector 12 rotate, the two slat weather strips 14 and the connector weather strip 15, which are described below, may be interposed between the two adjacent slats 11 and the connector 12.

Regardless of the spreading-out or zigzag-folding of the cover unit 10, the weather strip (14/15) capable of sealing the gap between the slat 11 and the connector 12 may be provided between the slat 11 and the connector 12.

The weather strip 14 and 15 may include the slat weather strip 14 sealing the gap between the slat 11 and the connector 12 by being inserted into the slat 11, or the connector weather strip 15 sealing a gap between the two adjacent slats 11 by being inserted into the connector 12.

The slat weather strip 14 and the connector weather strip 15 may be manufactured of flexible material, such as rubber. When the cover unit 10 is spread out or folded in a zigzag manner, cross-sectional shapes of the slat weather strip 14 and the connector weather strip 15 may be deformed between the two adjacent slats 11 and the connector 12, thereby coming into close contact with the two adjacent slats 11 or the connector 12 and sealing the gaps therebetween.

The slat weather strip 14 may be fixed into a space formed by the extension portions 11a and 11b at the end portion of the slat 11 by being inserted thereinto, and comes into close contact with an outside surface of the connector 12, thereby sealing the gap between the slat 11 and the connector 12. In a state of being fixed to the slat 11, the slat weather strip 14 surrounds the outside surface of the connector 12, thereby sealing the gap between the slat 11 and the connector 12.

To this end, the slat weather strip 14 may include a first fastening portion 14a, the first sealing portion 14c, a second sealing portion 14d, a connection portion 14e, and a first neck portion 14b. The first fastening portion 14a may fasten the slat weather strip 14 to the slats 11 by being inserted into the slat 11. The first sealing portion 14c may be convexly formed toward the connector 12 to come into contact with the connector 12. The second sealing portion 14d may come into contact with the connector 12 to surround one side thereof. The connection portion 14e may connect the first sealing portion 14c and the second sealing portion 14d to each other. The first neck portion 14b may be formed between the first fastening portion 14a and the connection portion 14e in such a manner as to have a smaller width the first fastening portion 14a.

The first fastening portion 14a may be inserted into the first weather strip insertion portion 11c, thereby fixing the slat weather strip 14 to the slat 11. In other words, the first fastening portion 14a may be positioned within the space in the first weather strip insertion portion 11c. The first neck portion 14b may be coupled with the first weather strip insertion portion 11c.

The first sealing portion 14c and the second sealing portion 14d may be connected by the connection portion 14e. The connection portion 14e may be connected to the first neck portion 14b, and the slat weather strip 14 may be integrally formed.

The first sealing portion 14c may be formed to extend from the connection portion 14e along the extension portion (11a/11b). In addition, the first sealing portion 14c may be supported on an inner surface of the extension portion 11a and 11b. The first sealing portion 14c may be convexly formed toward the convex portion 12c of the connectors 12. The first sealing portion 14c and the convex portion 12c may be convexly formed to face each other, thereby readily coming into contact with each other. Thus, the gap between the extension portion 11a and 11b on the slat 11 and the connectors 12 may be sealed.

The second sealing portion 14d may be bent toward the first sealing portion 4c. In other words, the second sealing portion 14d may be formed in the shape of the letter “U” to surround the outer surface of the connector 12, thereby sealing the gap between the slat 11 and the connector 12.

A protrusion 14da may be formed on a portion of the second sealing portion 14d that extends toward the first sealing portion 14c.

The slat weather strip 14 may have the first sealing portion 14c and the second sealing portion 14d. When the cover unit 10 is spread out or folded in a zigzag manner, although the slat 11 and the connector 12 change in shape, the gap therebetween may be sealed. Particularly, the protrusion 14da formed on the slat weather strip 14, along with an end portion of the second sealing portion 14d, may bring the second sealing portion 14d into contact with the outer surface of the connectors 12.

The connector weather strip 15 may be fixed to the connectors 12 by being inserted thereinto, thereby the gap between the two adjacent slats 11. The connector weather strip 15 may be installed into the connector 12 by being inserted between the convex portions 12c.

The connector weather strip 15 may include a second fastening portion 15a, a third sealing portion 15c, and a second neck portion 15b. The second fastening portion 15a may fasten the connector weather strip 15 to the connectors 12 by being inserted into the connectors 12. When the cover unit 10 is spread out, the third sealing portion 15c may come into the extension portions 11a and 11b of two adjacent slats 11, thereby sealing the gap therebetween. The second neck portion 15b may be formed to have a smaller width than the second fastening portion 15a and connects the second fastening portion 15a and the third sealing portion 15c to each other.

The second fastening portion 15a may be fastened to the second weather strip insertion portion 12d by being inserted thereinto. The second weather strip insertion portion 12d may have a space formed inside. When the second neck portion 15b is positioned in an opening in the second weather strip insertion portion 12d and the second fastening portion 15a is positioned within an opening in the second weather strip insertion portion 12d, the connector weather strip 15 may be installed in a state where the second fastening portion 15a is fastened to the second weather strip insertion portion 12d.

The third sealing portion 15c may have a space inside. Thus, when the cover unit 10 is spread out, both sides of the third sealing portion 15c may come into contact with the extension portions 11a and 11b, respectively, on the two adjacent slats 11, thereby sealing a gap therebetween.

When the cover unit 10 is folded in a zigzag manner, the third sealing portion 15c may be spaced away from the extension portions 11a and 11b on the two adjacent slats 11.

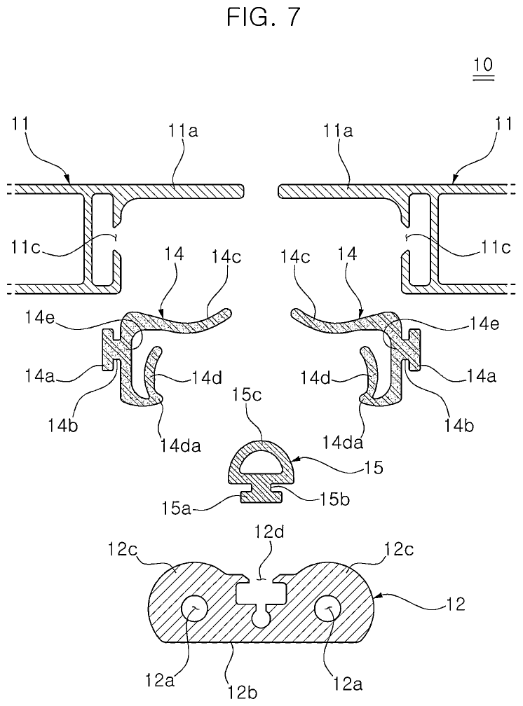

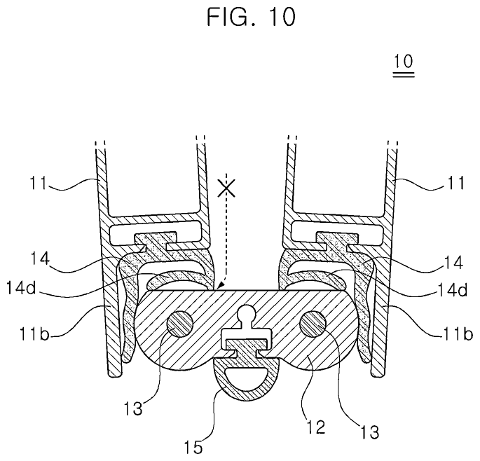

The third sealing portion 15c may be formed in such a manner that a width thereof increases toward the second neck portion 15b from an end of the third sealing portion 15c. The reason for this is that, when the cover unit 10 is spread out or folded in a zigzag manner, the extension portion 11a and 11b on the slat 11 may readily come into contact with the third sealing portion 15c or moves away therefrom. For example, FIGS. 6, 7, and 9 each illustrate that the width of the third sealing portion 15c increases toward the lower end of the figure. FIGS. 8 and 10 each illustrate that the width of the third sealing portion 15c increases toward the upper ends of the figure.

The operation of the folding type cargo compartment cover unit, configured as described above, according to the present disclosure, is described as follows.

FIGS. 6 and 8 illustrate a cross section of a portion of the cover unit 10 where slats 11 and the connectors 12 may be connected in a state where the cover unit 10 is spread out.

In the state where the cover unit 10 is spread out, the upper extension portions 11a on the adjacent slats 11 may be arranged adjacent to each other (refer to FIG. 6), and the lower extension portions 11b (refer to FIG. 8) on the adjacent slats 11 may be arranged adjacent to each other.

In a portion of the cover unit 10 where the upper extension portions 11a are arranged adjacent to each other, a gap between the upper extension portions 11a may be sealed with the connector weather strip 15, thereby preventing moisture or foreign material from penetrating into the vehicular cargo compartment.

In a portion of the cover unit 10 where the lower extension portion 11b are arranged adjacent to each other, the second sealing portion 14d of the slat weather strip 14 may seal the gap between the slat 11 and the connectors 12. The second sealing portion 14d may come into close contact with the connectors 12 while surrounding the connector 12. Thus, the second sealing portion 14d may seal the gap between the slat 11 and the connector 12. In addition, the first sealing portion 14c of the slat weather strip may seal a gap between the connectors 12 and the extension portion (11a/11b), realizing double sealing.

FIGS. 9 and 10 illustrate that a portion of the cover unit 10 where the connector 12 and the adjacent slats 11 may be connected in a state where the cover unit 10 is folded in a zigzag manner.

In the state where the cover unit 10 is folded in a zigzag manner, the slat weather strip 14 may come into close contact with the connectors 12, thereby sealing the gap between slat 11 and the connectors 12. For example, in FIG. 9, the first sealing portion 14c of the slat weather strip 14 may seal a gap between the upper extension portion 11a of the slat 11 and the connectors 12. In FIG. 10, the second sealing portion 14d of the slat weather strip 14 may seal the gap between the slat 11 and the connector 12.

What is claimed is:

1. A cover unit with a sealing structure for a cargo compartment of a vehicle, the cover unit comprising:
a plurality of slats successively arranged on top of the cargo compartment along a first direction of the vehicle;
connectors, each being arranged between adjacent slats of the plurality of slats;
shafts, each hinge-connecting one slat of the adjacent slats to a connector among the connectors by passing through the one slat and the connector; and
weather strips, each being formed of flexible material and being provided on at least one of the slat or the connector, thereby sealing a gap between the slat and the connector.

2. The cover unit of claim 1, wherein the weather strips include a slat weather strip fixed by being inserted into an end portion of the slat and sealing a gap between the slat and the connector by coming into close contact with an outside of the connector.

3. The cover unit of claim 2, wherein the slat weather strip comprises:
a first fastening portion fastening the slat weather strip to the slat by being inserted into the slat;
a first sealing portion convexly formed toward the connector to come into contact with the connector;
a second sealing portion coming into contact with the connector to surround one side thereof;
a connection portion connecting the first sealing portion and the second sealing portion to each other; and
a first neck portion formed between the first fastening portion and the connection portion and having a width smaller than a width of the first fastening portion.

4. The cover unit of claim 3, wherein the slat includes a first weather strip insertion portion in a form of hole elongated along a lengthwise direction of the slat, and
wherein the first fastening portion is inserted into the first weather strip insertion portion.

5. The cover unit of claim 4, wherein the connector has convex portions convexly formed to come into contact with the first sealing portions, respectively, and the first sealing portion is convexly formed toward the convex portions.

6. The cover unit of claim 5, wherein extension portions are formed on the plurality of slats toward the adjacent slats, respectively, and
wherein the first sealing portion is supported on an inner surface of the extension portions.

7. The cover unit of claim 6, wherein the extension portions extend from an upper surface or lower surface of each slat of the plurality of slats.

8. The cover unit of claim 5, wherein a flat portion is formed in an opposite direction to the convex portions.

9. The cover unit of claim 4, wherein the second sealing portion extends from the connection portion in a direction of moving away from the first sealing portion and then extends backward toward the first sealing portion.

10. The cover unit of claim 9, wherein a protrusion is formed on a portion of the second sealing portion that extends toward the first sealing portion.

11. The cover unit of claim 3, wherein a through-hole in the connector into which the shaft is inserted is provided in pairs and thus the connector is hinge-connected to the adjacent slats.

12. The cover unit of claim 1, wherein the weather strips includes a connector weather strip that is fixed to the connector by being inserted thereinto and seals a gap between the adjacent slats.

13. The cover unit of claim 12, wherein the connector weather strip comprises:
a second fastening portion fastening the connector weather strip to the connector by being inserted into the connector;
a third sealing portion coming into contact with the adjacent slats, thereby sealing a gap therebetween, when the cover unit is spread out; and
a second neck portion formed to have a width smaller than a width of the second fastening portion and connecting the second fastening portion and the third sealing portion to each other.

14. The cover unit of claim 13, wherein a second weather strip insertion portion is formed in a shape of an elongated hole in the connector along a lengthwise direction of the connector, and
wherein the second fastening portion is inserted into the second weather strip insertion portion.

15. The cover unit of claim 13, wherein the third sealing portion has a space inside.

16. The cover unit of claim 15, wherein the third sealing portion is formed in such a manner that a width thereof increases toward the second neck portion from an end of the third sealing portion.

17. The cover unit of claim 13, wherein extension portions are formed on the adjacent slats, respectively, and
wherein the third sealing portion seals a gap between the extension portions.

18. The cover unit of claim 17, wherein the extension portions respectively extend from an upper surface and a lower surface of the slat.

19. The cover unit of claim 18, wherein the adjacent slats are formed in such a manner as to have the same height when the cover unit is spread out.
